(19) United States
(12) Patent Application Publication
(10) Pub. No.: US 2013/0177794 A1
(43) Pub. Date: Jul. 11, 2013

(54) BATTERY MODULE

(71) Applicant: Kyung-Sub Shim, Yongin-si (KR)

(72) Inventor: Kyung-Sub Shim, Yongin-si (KR)

(73) Assignee: Samsung SDI Co., Ltd., Yongin-si (KR)

(21) Appl. No.: 13/540,836

(22) Filed: Jul. 3, 2012

(30) Foreign Application Priority Data
Jan. 5, 2012 (KR) 10-2012-0001548

(51) Int. Cl. H01M 2/10

(52) U.S. Cl. 429/99

(57) ABSTRACT

A battery module is disclosed. In one embodiment, the battery module includes a module case including a plurality of receiving units and a plurality of unit batteries arranged in the receiving units of the module case, respectively. The battery module may further include a mis-assembly prevention structure configured to couple the unit batteries to the module case and to substantially align each of the unit batteries with the corresponding receiving unit of the module case. The mis-assembly prevention structure may include i) a plurality of first pairs of alignment members formed in the unit batteries, respectively, in substantially diagonal directions with respect to the unit batteries and ii) a plurality of second pairs of alignment members formed in the receiving units of the module case, respectively, in substantially diagonal directions with respect to the receiving units.

### RELATED APPLICATIONS

This application claims the benefit of Korean Patent Application No. 10-2012-0001548, filed on Jan. 5, 2012, in the Korean Intellectual Property Office, the disclosure of which is incorporated herein in its entirety by reference.

### BACKGROUND

1. Field

The described technology generally relates to battery modules.

2. Description of the Related Technology

Secondary batteries have been applied to many products, and thus, are widely used as energy sources in mobile electronic devices such as digital cameras, cellular phones, and laptop computers. Recently, secondary batteries have been highlighted as an energy source of hybrid electric vehicles and electric vehicles that reduce environmental pollution caused by conventional internal-combustion engines using fossil fuel. Such secondary batteries are generally packaged in a module case, and are sold as modules.

### SUMMARY

One inventive aspect is a mis-assembly prevention unit for easily arranging assembly orientations of unit batteries directly related with polarity connections between the unit batteries and easily checking mis-assembly.

Another aspect is a battery module which includes a module case; a plurality of unit batteries arranged in the module case; and mis-assembly prevention coupling mechanisms which are used to couple the unit batteries to the module case and to arrange assembly orientations of the unit batteries in a regular pattern in a direction where the unit batteries are aligned, wherein the mis-assembly prevention coupling mechanisms form pairs on diagonal directions of the unit batteries.

The mis-assembly prevention coupling mechanisms for restricting adjacent unit batteries may be formed on a first diagonal and a second diagonal intersecting each other in a direction in which the unit batteries are aligned.

Each of the unit batteries may include a first edge via which a first electrode tab and a second electrode tab are drawn out, and a third edge and a fourth edge which contact the first edge and are opposite to each other, and the mis-assembly prevention coupling mechanisms may form pairs on diagonal directions of the unit batteries on the third and fourth edges.

The mis-assembly prevention coupling mechanisms may arrange the unit batteries in a horizontal inversion pattern where positions of the third and fourth edges of one unit battery are inverted from the third and fourth edges of an adjacent unit battery.

The first and second electrode tabs of one unit battery may be disposed adjacent to the second and first electrode tabs of an adjacent unit battery, respectively.

The first and second electrode tabs may have opposite polarities, and the adjacent first and second electrode tabs may be serially connected to each other.

Each of the mis-assembly prevention coupling mechanisms may include two lock portions arranged on a diagonal of each of the unit batteries; and two lock portions arranged on a diagonal of the module case so as to engage with the two lock portions.

When the lock portions of one unit battery are formed on a first diagonal, the lock portions of an adjacent unit battery may be formed on a second diagonal intersecting the first diagonal.

The module case may include a plurality of receiving grooves for receiving the unit batteries, respectively. When the lock portions of one receiving groove are formed on a first diagonal, the lock portions of an adjacent receiving groove may be formed on a second diagonal intersecting the first diagonal.

When the two lock portions of the unit battery are formed on a first diagonal and the two lock portions of the module case are formed on the first diagonal, no lock portions of the unit battery and no lock portions of the module case may be formed on a second diagonal intersecting the first diagonal.

The lock portions of the unit battery and the lock portions of the module case may include protrusions having a wedge shape.

Each of the lock portions of the unit battery and the module case may include a first plane having a sloping plane inclined in a direction where the unit batteries are inserted into the module case; and a second plane that is substantially perpendicular to the insertion direction to block deviation of the unit battery from the module case.

The second planes of the lock portion of the unit battery and the lock portion of the module case may contact each other and form a stopper for blocking deviations from each other.

One of the lock portion of the unit battery and the lock portion of the module case may include a protrusion, and the other may include a notch for receiving the protrusion.

The protrusion and the notch may be correspondingly shaped.

An insulation plate, which covers an upper surface of an array of the unit batteries, may be disposed on the module case.

A plurality of slit-type openings through which the electrode tabs of the unit batteries are drawn out may be formed in parallel in the insulation plate.

The electrode tab drawn out of one unit battery may overlap with the electrode tab drawn out of an adjacent unit battery on the insulation plate, and the electrode tab drawn out of the one unit battery may be electrically connected to the electrode tab drawn out of the adjacent unit battery via a bus bar seated on the insulation plate. Another aspect is a battery module comprising: a module case comprising a plurality of receiving units; a plurality of unit batteries arranged in the receiving units of the module case, respectively; and a mis-assembly prevention structure configured to couple the unit batteries to the module case and to substantially align each of the unit batteries with the corresponding receiving unit of the module case, wherein the mis-assembly prevention structure comprises i) a plurality of first pairs of alignment members formed in the unit batteries, respectively, in substantially diagonal directions with respect to the unit batteries and ii) a plurality of second pairs of alignment members formed in the receiving units of the module case, respectively, in substantially diagonal directions with respect to the receiving units.

In the above module, adjacent pairs of the first alignment members are formed in first and second diagonal directions of the unit batteries, respectively, and wherein the first and second diagonal directions intersect each other. In the above module, each of the unit batteries comprises i) a first edge via which a first electrode tab and a second electrode tab are drawn out, ii) a second edge opposing the first edge, and iii) a third edge and a fourth edge connected to the first and second edges and are opposite to each other, and wherein the first pairs of alignment members are formed on the third and fourth edges of the unit batteries.

In the above module, the first and second electrode tabs of one unit battery are disposed adjacent to the second and first electrode tabs of an adjacent unit battery, respectively. In the above module, the first and second electrode tabs have opposite polarities, and wherein the adjacent first and second electrode tabs are serially connected to each other. In the above module, adjacent pairs of the second alignment members are formed in first and second diagonal directions of the receiving units of the module case, respectively, and wherein the first and second diagonal directions intersect each other. In the above module, each pair of the first alignment members comprise two lock portions arranged on a diagonal of the respective unit battery, and wherein each pair of the second alignment members comprise two lock portions arranged on a diagonal of the respective receiving unit of the module case so as to engage with the lock portions of the unit battery.

In the above module, the lock portions of one unit battery are formed on a first diagonal, and wherein the lock portions of an adjacent unit battery are formed on a second diagonal intersecting the first diagonal. In the above module, the receiving units comprise grooves configured to at least partially receive the first alignment members of the unit batteries, respectively. In the above module, the lock portions of the unit battery are formed on a first diagonal of the corresponding unit battery, wherein the lock portions of the module case are formed on the first diagonal of the corresponding receiving unit of the module case, and wherein no lock portions of the corresponding unit battery and no lock portions of the corresponding receiving unit of the module case are formed on a second diagonal intersecting the first diagonal.

In the above module, the lock portions of the unit battery and the lock portions of the module case comprise protrusions having a wedge shape. In the above module, each of the lock portions of the unit battery and the module case comprises: a first surface inclined in a direction where the unit batteries are inserted into the receiving units of the module case; and a second surface that is substantially perpendicular to the insertion direction to substantially block deviation of the unit battery from the module case. In the above module, the second surfaces of the lock portions of the unit battery and the second surfaces of the lock portions of the module case contact each other and form a stopper to substantially block deviations from each other.

In the above module, one of i) the lock portions of the unit battery and ii) the lock portions of the module case comprise a protrusion, and wherein the other comprise a notch configured to receive the protrusion. In the above module, the protrusion and the notch have substantially similar shapes. The above module further comprises an insulation plate, which covers an upper surface of an array of the unit batteries, disposed on the module case. In the above module, a plurality of slit-type openings through which electrode tabs of the unit batteries are drawn out are formed substantially parallel with each other in the insulation plate. In the above module, a first electrode tab of one unit battery at least partially overlaps with a second electrode tab of an adjacent unit battery on the insulation plate, and wherein the first and second electrode tabs are electrically connected to each other via a bus bar seated on the insulation plate.

Another aspect is a battery module comprising: a module case comprising a plurality of receiving units; and a plurality of unit batteries arranged in the receiving units of the module case, respectively, wherein a plurality of first pairs of alignment members are formed in the unit batteries, respectively, in substantially diagonal directions with respect to the unit batteries, wherein a plurality of second pairs of alignment members are formed in the receiving units of the module case, respectively, in substantially diagonal directions with respect to the receiving units, and wherein each of the first pairs of alignment members is configured to at least partially engage with the corresponding second pair of alignment members.

In the above module, adjacent pairs of the first alignment members are formed in first and second diagonal directions of the unit batteries, respectively, wherein the first and second diagonal directions cross each other, wherein adjacent pairs of the second alignment members are formed in third and fourth diagonal directions of the receiving units, respectively, and wherein the third and fourth diagonal directions cross each other.

### BRIEF DESCRIPTION OF THE DRAWINGS

FIG. 1 is an exploded perspective view of a battery module according to an embodiment.

FIGS. 2A and 2B are perspective views of unit batteries included in the battery module shown in FIG. 1.

FIG. 3 schematically illustrates an internal structure of a module case included in the battery module shown in FIG. 1.

FIGS. 4A and 4B are cross-sectional views for explaining an operation of a mis-assembly prevention coupling mechanism formed on a first diagonal.

FIGS. 5A and 5B are cross-sectional views for explaining an operation of a mis-assembly prevention coupling mechanism formed on a second diagonal.

FIG. 6 illustrates a unit battery assembled in an incorrect orientation.

FIG. 7 illustrates a plurality of unit batteries connected to one another in series.

FIG. 8 is an exploded perspective view of a battery module according to another embodiment.

FIGS. 9A and 9B are cross-sectional views for explaining a mis-assembly prevention coupling mechanism applicable to another embodiment.

FIGS. 10A and 10B are cross-sectional views for explaining a mis-assembly prevention coupling mechanism applicable to another embodiment.

### DETAILED DESCRIPTION

A high-output, high-capacity secondary battery may be provided by connecting a plurality of unit batteries, containing battery cells, serially and/or in parallel in a battery module. When polarity connections are erroneously made among the unit batteries, charging and discharging operations cannot be properly performed, and safety and integrity are compromised.

Embodiments will be described with respect to the accompanying drawings, wherein like reference numerals refer to like elements throughout. In this regard, the present embodiments may have different forms and should not be construed as being limited to the descriptions set forth herein.

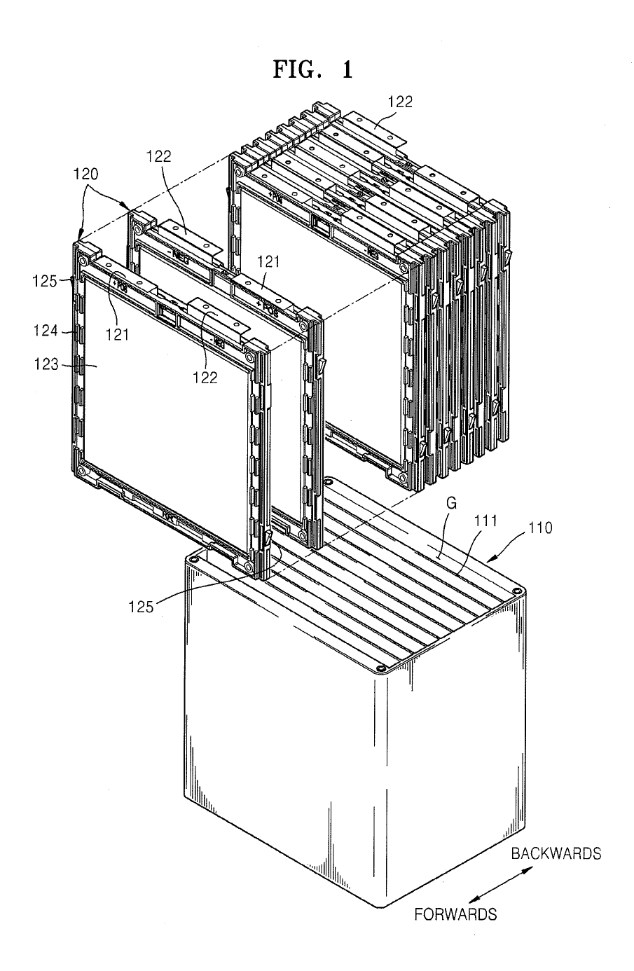

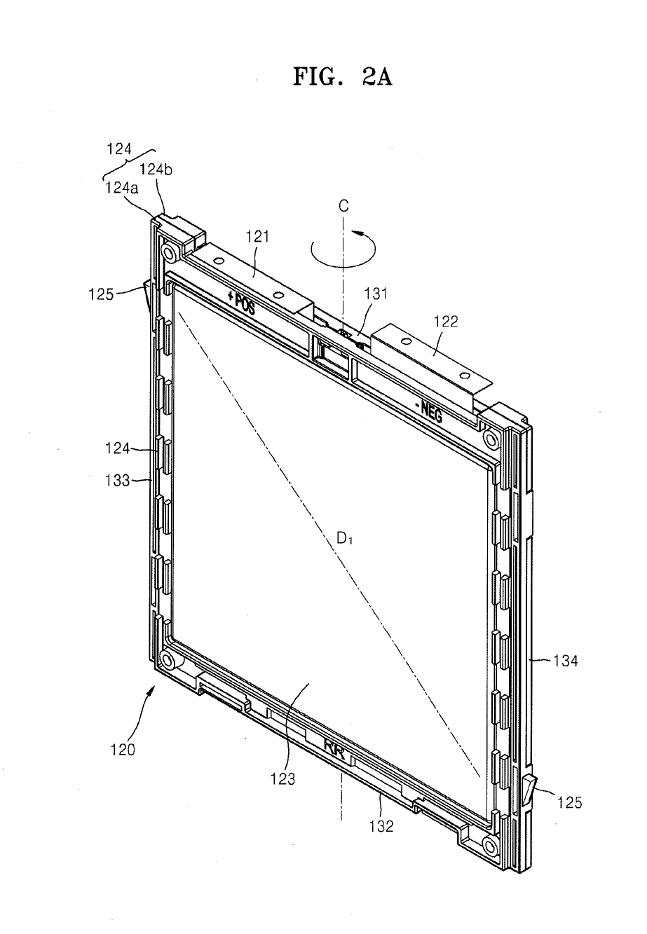

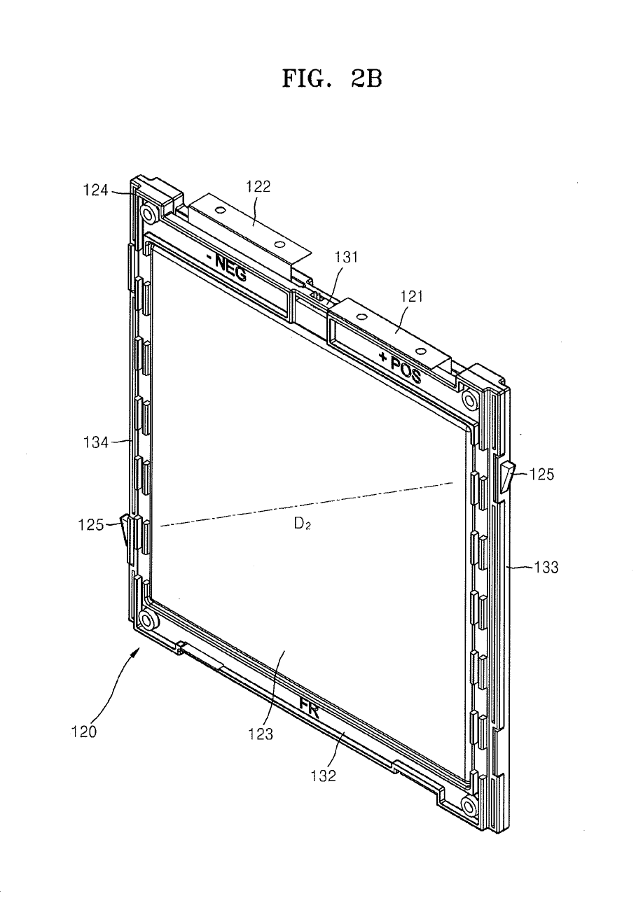

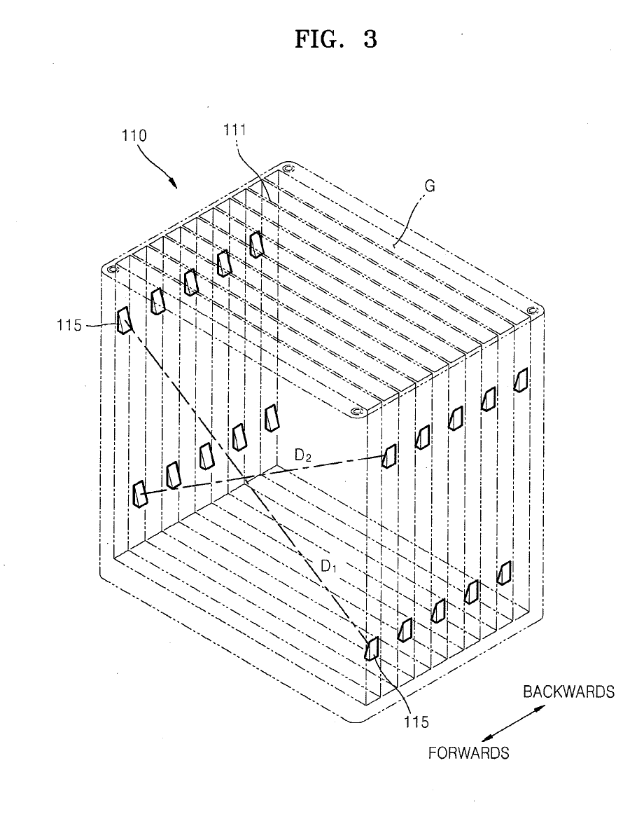

FIG. 1 is an exploded perspective view of a battery module according to an embodiment. FIGS. 2A and 2B are perspective views of a plurality of unit batteries 120 shown in FIG. 1. FIG. 3 schematically illustrates an internal structure of a module case 110 shown in FIG. 1.

Referring to FIG. 1, the battery module includes the unit batteries 120, and the module case 110 for receiving the unit batteries 120. The unit batteries 120 may be aligned forwards and backwards and may be received in the module case 110. The module case 110 provides a receiving space for keeping the unit batteries 120 to form a module.

The module case 110 may have a quasi-hexahedron shape and provides a receiving space (or receiving units) for keeping the unit batteries 120. For example, barrier walls 111 for defining respective receiving grooves G of the unit batteries 120 or guiding insertion of the unit batteries 120 into the receiving grooves G may be formed in the module case 110. The barrier walls 111 may define the respective receiving grooves G of the unit batteries 120 and may separate adjacent receiving grooves G from each other.

According to another embodiment, the barrier walls 111 may not be provided. The barrier walls 111 may be replaced by a guide rail (not shown) which is formed to define the respective receiving grooves G of the unit batteries 120 or to guide insertion of the unit batteries 120. In this case, the guide rail may protrude from a lateral surface of the module case 110 by a predetermined length.

Referring to FIG. 2A, each of the unit batteries 120 may be formed in substantially a planar shape. Each of the unit batteries 120 may include a battery cell 123, and a frame 124 for supporting the battery cell 123. The battery cell 123 may be, for example, a lithium-ion battery. The frame 124 may extend along the edge of the battery cell 123 to cover the edge of the battery cell 123. For example, the frame 124 may include a first frame 124a and a second frame 124b which are coupled to each other on both sides of the battery cell 123. First and second lead tabs (interchangeably used with electrode tabs) 121 and 122 extending from the battery cell 123 may be drawn out via the frame 124. For example, the lead tabs 121 and 122 may be drawn outside the battery cell 123 through the space between the frames 124a and 124b. The lead tabs 121 and 122 may have opposite polarities and may be formed at left and right sides of one edge (for example, a first edge 131) of the unit battery 120.

The unit battery 120 may be formed in the shape of a substantially rectangular plate including first, second, third, and fourth edges 131, 132, 133, and 134. The first edge 131 is an upper edge of the unit battery 120 and the lead tabs 121 and 122 are drawn from the first edge 131. The second edge 132 is a lower edge thereof and extends substantially horizontally in substantially parallel to the first edge 131. The third and fourth edges 133 and 134 are left and right edges thereof and extend substantially perpendicular to the first and second edges 131 and 132 so as to be substantially parallel with each other between the two edges 131 and 132.

Lock portions (or a plurality of first pairs of alignment members) 125 may be formed on the third and fourth edges 133 and 134 of the unit battery 120. The portions 125 may make a pair on a first diagonal D1 on the third and fourth edges 133 and 134 and may be integrally formed with the frame 124. For example, when the lock portion 125 of the third edge 133 is formed relatively high, the lock portion 125 of the fourth edge 134 may be formed relatively low. One of the lock portions 125 may be located between the middle and the top of the third edge 133, and the other lock portion 125 may be located between the middle and the bottom of the fourth edge 134. The same may apply to lock portions 115 (a plurality of second pairs of alignment members; see FIGS. 3-6) with respect to the module case 110.

As is described below, the lock portions 125 together with lock portions 115 of the module case 110 may form mis-assembly prevention coupling mechanisms (or mis-assembly prevention structure). The mis-assembly prevention coupling mechanisms, including the lock portions 115 and 125, are used to couple the unit batteries 120 to the module case 110 and contribute to arrange assembly orientations of the unit batteries 120 in a regular pattern in a direction where the unit batteries 120 are aligned.

The assembly orientations of the unit batteries 120 may have a pattern where left and right sides of one unit battery 120 are inverted from those of an adjacent unit battery 120. For example, the third and fourth edges 133 and 134 of the one unit battery 120 are inverted from those of the adjacent unit battery 120, in a direction where the unit batteries 120 are aligned. FIGS. 2A and 2B illustrate unit batteries 120 of which left and right sides are inverted from each other therebetween. In other words, the unit batteries 120 shown in FIGS. 2A and 2B are different from each other in that their left and right sides are inverted from each other therebetween. For example, the orientation of the unit battery 120 of FIG. 2B is obtained by rotating the unit battery 120 of FIG. 2A about a center axis C of FIG. 2A.

When one unit battery 120 is arranged in the orientation of FIG. 2A, an adjacent unit battery 120 is arranged in the orientation of FIG. 2B. Accordingly, when the former unit battery 120 has lock portions 125, arranged on the first diagonal D1, the latter unit battery 120 has lock portions 125, arranged on a second diagonal D2. As such, the protrusions 125 of the unit batteries 120 are formed on the first and second diagonals D1 and D2 intersecting each other so that the diagonals D1 and D2 alternate along the arrangement of the unit batteries 120. This way, erroneous orientation of the unit batteries 120 (for example, an error in which adjacent unit batteries 120 are arranged without inversion between left and right sides thereof) may be prevented. By arranging orientations of the unit batteries 120 in a left-right inversion pattern, first and second electrode tabs 121 and 122 may be positioned adjacent to each other between adjacent unit batteries 120 in a forward-backward direction, and serial connection may be done by connecting the first and second electrode tabs 121 and 122 having opposite polarities to each other in a short distance.

Referring to FIG. 3, the receiving grooves G for keeping the unit batteries 120, respectively, may be arranged in a forward-backward direction within the module case 110. Each of the receiving grooves G includes lock portions 115 that form a mis-assembly prevention coupling mechanism together with the lock portions 125 of each of the unit batteries 120. For example, the lock portions 115 may make a pair by being arranged on the first or second diagonal D1 or D2 and may be integrally formed with the module case 110.

The first and second diagonals D1 and D2 on which pairs of the lock portions 115 are arranged alternate with each other in the frontward-backward direction, as shown in FIG. 3. For example, the lock portions 115 of one receiving groove G are arranged on the first diagonal D1, and the lock portions 115 of an adjacent receiving groove G are arranged on the second diagonal D2 intersecting the first diagonal D1.

A pair of the lock portions 125 (see FIG. 2A) of one unit battery 120 and a pair of the lock portions 115 (see FIG. 3) of a receiving groove G receiving a unit battery 120 are each arranged on the first diagonal D1, and the lock portions 125 are engaged with and coupled to the lock portions 115 on the first diagonal D1.

A pair of the lock portions 125 (see FIG. 2B) of an adjacent unit battery 120 and a pair of the lock portions 115 (see FIG. 3) of a receiving groove G receiving an adjacent unit battery 120 are each arranged on the second diagonal D2, and the lock portions 125 are engaged with and coupled to the lock portions 115 on the second diagonal D2.

Mis-assembly prevention coupling mechanisms, including the lock portions 115 and 125 for restricting two adjacent unit batteries 120, respectively, are formed on the first and second diagonals D1 and D2, respectively, intersecting each other, and unit batteries assembled in erroneous orientations are not coupled to the module case 110 but are detached from the module case 110 by the mis-assembly prevention coupling mechanisms. In one embodiment, when a unit battery 120 having lock portions 125 arranged on the first diagonal D1 is received in a receiving groove G having lock portions 115 arranged on the second diagonal D2, the lock portions 125 on the first diagonal D1 fail to couple to the lock portions 115 on the second diagonal D2 and thus pop out of the receiving groove G even by a small movement. Accordingly, an operator may recognize the incorrect orientation of the unit battery 120 and may re-assemble the unit battery 120 by switching its left and right sides, that is, by changing the orientation of the unit battery 120, so that the lock portions 125 are arranged on the second diagonal D2 and may couple to the lock portions 115 arranged on the second diagonal D2.

The mis-assembly prevention coupling mechanisms, each including the lock portions 115 and 125, in the battery module including the electrically-connected unit batteries 120 may prevent incorrect polarity connection between adjacent unit batteries 120 due to incorrect horizontal orientations between the adjacent unit batteries 120, which is referred to as a mis-assembly of the unit batteries 120, and may enable an operator to easily recognize the incorrect horizontal orientations between the unit batteries 120.

In the structure of a serial module, the unit batteries 120 are oriented in a pattern where left and right sides of one unit battery 120 are inverted from those of an adjacent unit battery 120, so that opposite polarities between adjacent unit batteries 120 face each other and first and second electrode tabs 121 and 122 having opposite polarities are connected to each other to form serial connection. For example, the first lead tab 121 of one unit battery 120 faces and is connected to the second lead tab 122 of an adjacent unit battery 120, and the second lead tab 122 of the one unit battery 120 faces and is connected to the first lead tab 121 of the adjacent unit battery 120, thereby forming serial connection.

If adjacent unit batteries 120, which are adjacent in a forward-backward direction, are assembled in erroneous orientations without horizontal inversions between the adjacent unit batteries 120, same polarities face each other between the adjacent unit batteries 120. In other words, the first electrode tabs 121 of the adjacent unit batteries 120 are adjacent to each other and the second electrode tabs 122 thereof are adjacent to each other, and thus no proper serial connection is made and a connection error occurs.

As such, when the unit batteries 120 are mis-assembled due to an incorrect orientation pattern between adjacent unit batteries 120, charging and discharging operations cannot be properly performed due to a connection error between the unit batteries 120, and an unpredicted safety accident may occur. For example, the unit batteries 120 arranged in a forward-backward direction fail to entirely form serial connection, that is, partially form parallel connection, and thus, connections between the unit batteries 120 are unstable. The mis-assembly prevention coupling mechanisms each formed of the lock portions 115 and 125 may enable erroneous orientations of the unit batteries 120 to be easily detected during the assembly of the unit batteries 120 into the module case 110.

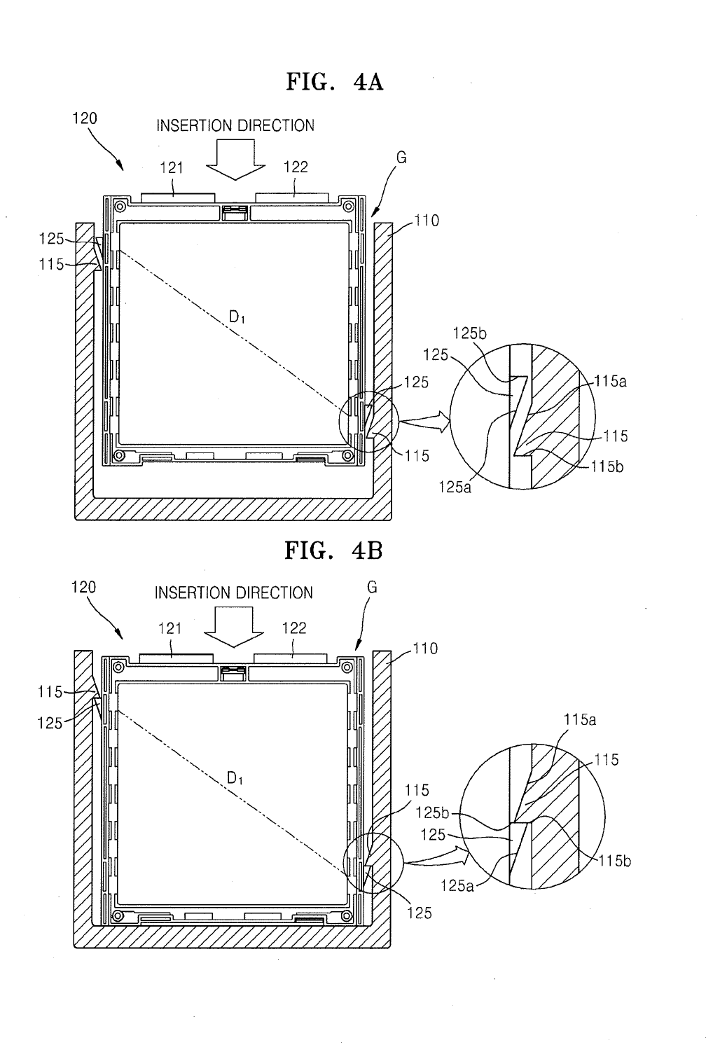

FIGS. 4A and 4B are cross-sectional views for explaining an operation of a mis-assembly prevention coupling mechanism formed of lock portions 115 and 125 arranged on the first diagonal D1. The mis-assembly prevention coupling mechanism may include lock portions 125 formed on a unit battery 120 and lock portions 115 formed on the module case 110. The lock portions 125 and 115 may be formed at corresponding locations, namely, on the first diagonal D1 that enables the lock portions 125 and 115 to mechanically interfere with each other and to engage with each other. In one embodiment, the lock portions 125 of the unit battery 120 and the lock portions 115 of the module case 110 interlock with each other and form stoppers, and substantially prevents the unit battery 120 from detaching from the module case 110.

The unit battery 120 slidingly couples to the module case 110 due to the mis-assembly prevention coupling mechanism, and the unit battery 120 and the module case 110 mechanically combine. By slidingly coupling, the unit battery 120 slides into the module case 110 and is smoothly fixed thereto. Thus, the unit battery 120 having reached an assembly location may be firmly in the module case 110, and detachment of the unit battery 120 may be substantially prevented.

Each of the lock portions 125 formed on the unit battery 120 may be formed in the shape of a wedge having first and second planes 125a and 125b (or first and second surfaces) having different inclinations, to allow movements in an insertion direction and substantially block movements in a removal direction. For example, the first plane 125a may be a sloping plane inclined at a first angle in a direction in which the unit battery 120 is inserted, and the second plane 125b may be a plane that is substantially perpendicular to the direction in which the unit battery 120 is inserted, to substantially block movements in a direction in which the unit battery 120 is removed. As described below, the second plane 125b of the lock portion 125 engages with a second plane 115b of a lock portion 115 corresponding to the lock portion 125 and forms a stopper.

Each of the lock portions 115 formed on the module case 110 may be formed in the shape of a wedge having first and second planes 115a and 115b having different inclinations, to allow movements in the insertion direction of the unit batteries 120 and substantially block movements in the removal direction of the unit batteries 120. For example, the first plane 115a may be a sloping plane inclined at a second angle in the insertion direction of the unit batteries 120, and the second plane 115b may be a plane that is substantially perpendicular to the insertion direction of the unit batteries 120, to substantially block movements in the removal direction of the unit batteries 120. In one embodiment, the second angle is similar to or substantially the same as the first angle. The second plane 115b of the lock portion 115 engages with the second plane 125b of the lock portion 125 corresponding to the lock portion 115 and forms a stopper.

When the unit battery 120 is inserted into the module case 110, the first planes 125a of the lock portions 125 may slide into the module case 110 while contacting the first planes 115a of the lock portions 115 in the insertion direction. To this end, the first planes 125a and 115a of each lock portion 125 and 115 may have complementary inclinations. When the unit battery 120 reaches an assembly location in the module case 110, the second planes 125b of the lock portions 125 contact the second planes 115b of the lock portions 115 and form stoppers as shown in FIG. 4B, and deviation of the unit battery 120 may be substantially prevented.

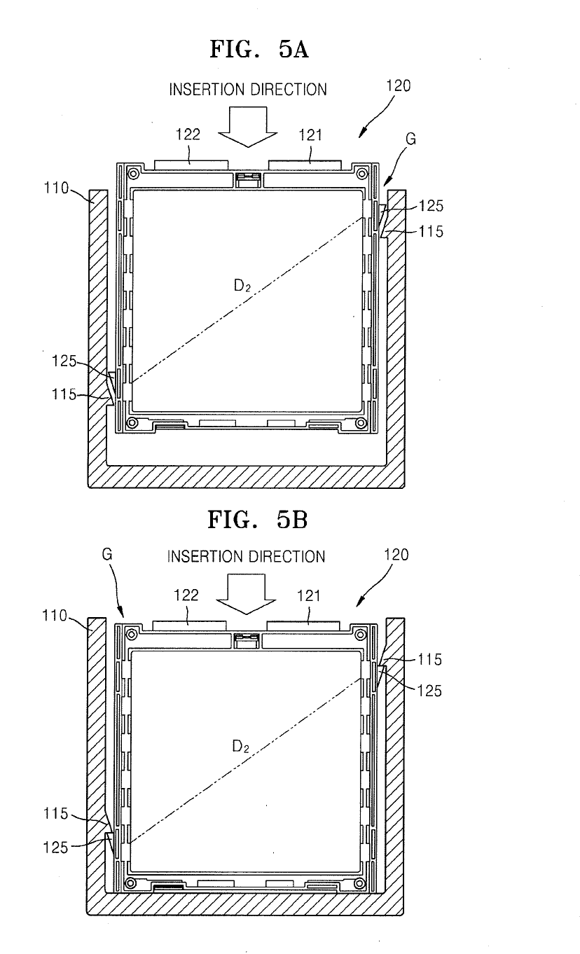

FIGS. 5A and 5B are cross-sectional views for explaining an operation of a mis-assembly prevention coupling mechanism formed of lock portions 115 and 125 arranged on the second diagonal D2. The mis-assembly prevention coupling mechanism may include lock portions 125 formed on a unit battery 120 and lock portions 115 formed on the module case 110, and the lock portions 125 and 115 may be formed at corresponding positions, namely, on the second diagonal D2 that enables the lock portions 125 and 115 to mechanically interfere with each other and to engage with each other. In one embodiment, the lock portions 125 of the unit battery 120 and the lock portions 115 of the module case 110 interlock with each other and form stoppers as shown in FIG. 5B, and substantially prevent the unit battery 120 from detaching from the module case 110.

For example, in a forward-backward direction where the unit batteries 120 are arranged, a front unit battery 120 and a front receiving groove G respectively have lock portions 125 and lock portions 115 arranged on the first diagonal D1 (see FIGS. 4A and 4B), and a rear unit battery 120 and a rear receiving groove G respectively have lock portions 125 and lock portions 115 arranged on the second diagonal D2 (see FIGS. 5A and 5B).

The lock portions 125 and 115 arranged on the first diagonal D1 of the front unit battery 120 and the front receiving groove G engage with each other. Furthermore, the lock portions 125 and 115 arranged on the second diagonal D2 of the rear unit battery 120 and the rear receiving groove G engage with each other. Accordingly, when left-right orientations of the unit batteries 120 are correct, the lock portions 125 and 115 of the unit batteries 120 and the receiving grooves G are engaged with each other, and the unit batteries 120 are not detached from the receiving grooves G. Accordingly, after the unit batteries 120 are assembled, mis-assembly of the unit batteries 120 may be checked via a simple operation of pulling out the unit batteries 120.

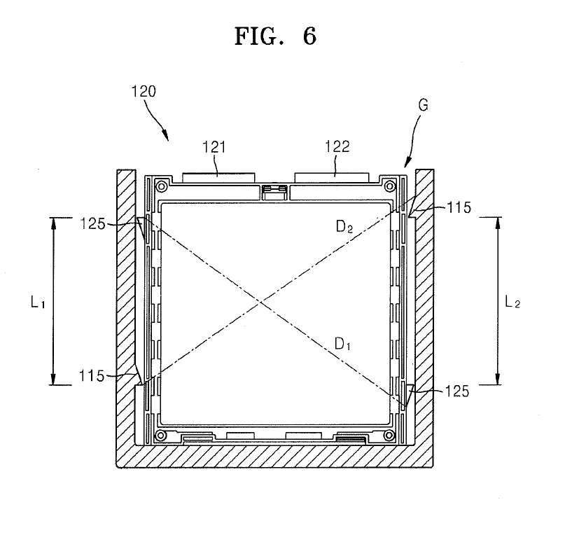

FIG. 6 illustrates a unit battery 120 assembled in an incorrect orientation. Referring to FIG. 6, when there is an error in the left-right orientation of the unit battery 120, for example, when two lock portions 125 formed on the unit battery 120 are arranged on the first diagonal D1 and two lock portions 115 formed on the module case 110 are arranged on the second diagonal D2, the lock portions 125 and 115 fail to couple to each other. In this situation, the unit battery 120 is easily deviated from the module case 110. In other words, the lock portion 125 and the lock portion 115 formed on one side are spaced apart from each other by a first distance L1, and the lock portions 125 and 115 formed on the other side are spaced apart from each other by a second distance L2.

Accordingly, after the unit battery 120 is assembled, mis-assembly of the unit battery 120 may be checked via a simple operation of pulling out the unit battery 120. When it is verified that the unit battery 120 has been misassembled, an operator may correct the mis-assembly by switching the left and right sides of the unit battery 120 and re-inserting the horizontally-switched unit battery 120 into the module case 110. As such, arrays of the lock portions 115 intersecting each other in a forward and backward direction of the module case 110 provide a unit that enables an operator to easily verify whether unit batteries 120 have been misassembled.

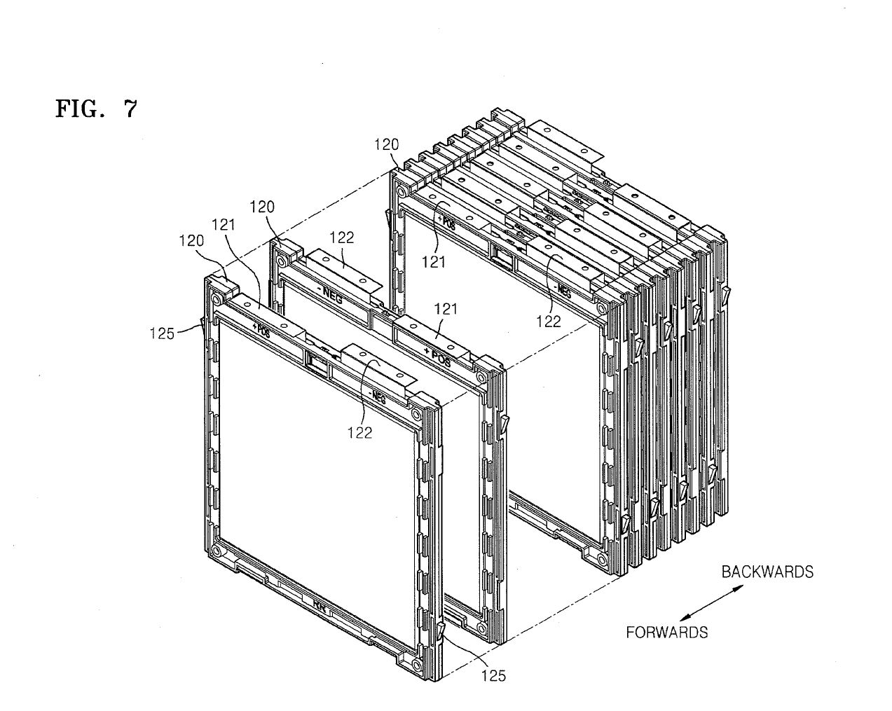

FIG. 7 illustrates a plurality of unit batteries 120 connected to one another in series. The unit batteries 120 aligned in a forward-backward direction may provide a high-output, high-capacity battery module by being electrically connected to one another.

Referring to FIG. 7, first and second lead tabs 121 and 122 drawn out of each unit battery 120 are bent in opposite directions, namely, forwards/backwards, along an array of the unit batteries 120. First and second lead tabs 121 and 122 bent from one unit battery 120 are disposed to at least partially overlap with those bent from an adjacent unit battery 120.

For example, a first lead tab 121 bent forwards from one unit battery 120 may be disposed to overlap with a second lead tab 122 bent backwards from an adjacent unit battery 120 in front, and the overlapping first and second lead tabs 121 and 122 may be electrically connected to each other to serially connect the two unit batteries 120.

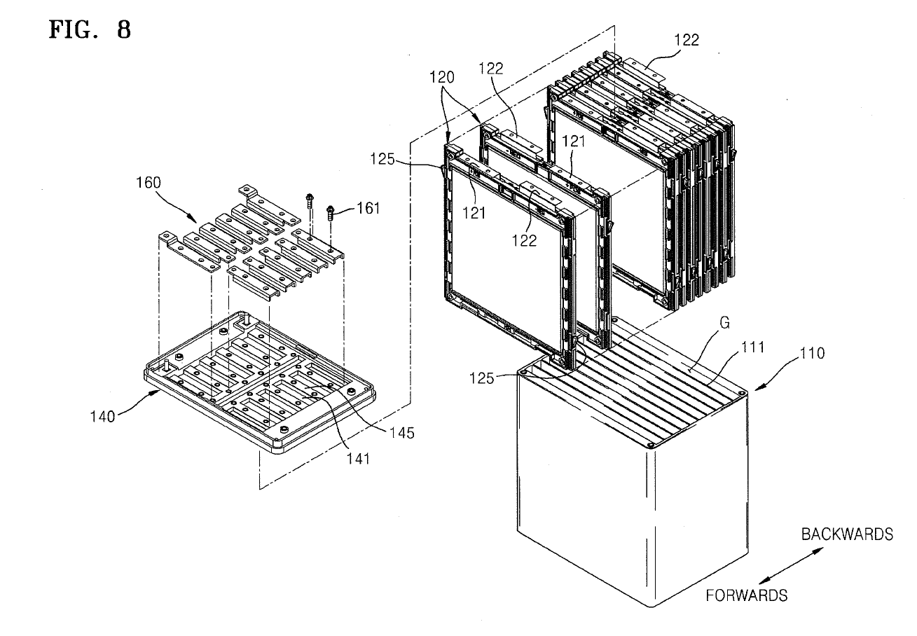

FIG. 8 is an exploded perspective view of a battery module according to another embodiment.

A first lead tab 121 bent forwards from one unit battery 120 may be disposed to at least partially overlap with a second lead tab 122 bent backwards from an adjacent unit battery 120 in front. The two front and rear unit batteries 120 may be serially connected to each other via the overlapping lead tabs 121 and 122.

Similarly, a second lead tab 122 bent backwards from one unit battery 120 may be disposed to at least partially overlap with a first lead tab 121 bent frontwards from an adjacent unit battery 120 in the rear. The two front and rear unit batteries 120 may be serially connected to each other via the overlapping lead tabs 121 and 122.

In the embodiment of FIG. 8, an insulation plate 140 may be assembled into the module case 110 for keeping the unit batteries 120, from above the module case 110. The insulation plate 140 may include a plurality of slit-type openings 141 through which lead tabs 121 and 122 of the unit batteries 120 are drawn outside. The first and second lead tabs 121 and 122 drawn out via the slit-type openings 141 at least partially overlap with each other on a support 145 of the insulation plate 140, and are electrically connected to each other via a bus bar 160 which is seated on the overlapping first and second lead tabs 121 and 122.

The lead tabs 121 and 122 of two adjacent unit batteries 120 may be drawn out via adjacent slit-type openings 141 of the insulation plate 140, be bent forwards/backwards, and then at least partially overlap with each other on the support 145 of the insulation plate 140. The bus bar 160 may be locked onto the support 145 of the insulation plate 140 on which the lead tabs 121 and 122 at least partially overlap with each other, for example, locked onto the support 145 of the insulation plate 140 with a fastener 161, and thus, the tabs 121 and 122 may be electrically connected to each other via the bus bar 160.

As described above, the left-right orientations of the unit batteries 120 may be properly arranged via the mis-assembly prevention coupling mechanisms (each including lock portions 115 and 125) provided on the unit batteries 120 and the module case 110, whereby proper polarity connections may be secured. In addition, the mis-assembly prevention coupling mechanisms may substantially prevent detachment of the unit batteries 120 from the module case 110. For example, the unit batteries 120 may be fixed by the lock portions 125 and 115 integrally formed with the unit batteries 120 and the module case 110 without using special locking units.

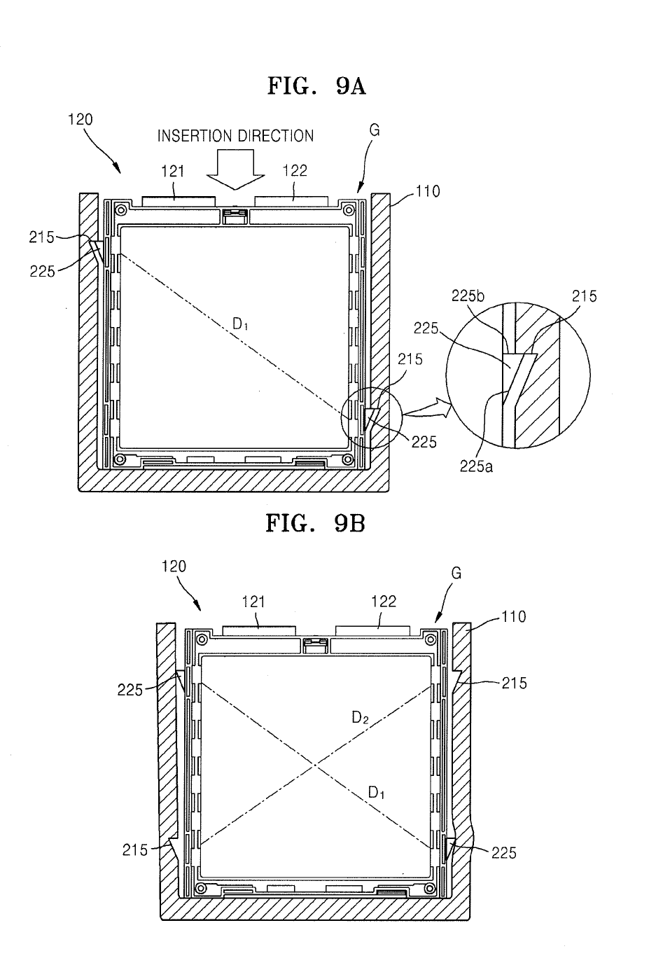

FIGS. 9A and 9B are cross-sectional views for explaining a mis-assembly prevention coupling mechanism applicable to another embodiment. Referring to FIGS. 9A and 9B, the mis-assembly prevention coupling mechanism includes lock portions 225 formed on a unit battery 120 and lock portions 215 formed on the module case 110. The lock portions 225 may be integrally formed with the unit battery 120 and may include protrusions, and the lock portions 215 may include notches in a shape complementary to that of the protrusions so as to receive the lock portions 225.

Each of the lock portions 225 of the unit battery 120 may protrude in the shape of a wedge having different inclinations. Each of the lock portions 225 may include a first plane 225a inclined in an insertion direction of the unit battery 120, and a second plane 225b that is substantially perpendicular to the insertion direction. The first plane 225a may have an inclined plane shape to reduce resistance to the insertion of the unit battery 120. The second plane 225b may have an upright or quasi-upright plane shape to form a stopper and block removal of the unit battery 120 from the module case 110. Each of the lock portions 215 of the module case 110 may be shaped to be combined with at least a part of each of the lock portions 225 so as to receive the at least part of each of the lock portions 225. Each of the lock portions 215 of the module case 110 may have a convex shape configured to receive at least part of the corresponding lock portion 225. The convex shape may include at least one linearly bent portion as shown in FIG. 9A. The convex shape may also include a non-linearly curved portion (not shown) as long as each of the lock portions 215 can receive at least part of its counterpart 225.

The lock portions 225 of the unit batteries 120 may be two locked portions 225 formed at facing positions on the first diagonal D1, and two lock portions 215 formed on the module case 110 may be arranged on the first diagonal D1 and face the two lock portions 225.

FIG. 9B illustrates a unit battery 120 assembled in an incorrect orientation. Referring to FIG. 9B, for example, when the left and right sides of the unit battery 120 are switched and assembled, the lock portions 225 are arranged on the first diagonal D1 and the lock portions 215 are arranged on the second diagonal D2. As a result, the lock portions 225 and the lock portions 215 are not coupled to each other and the unit battery 120 is easily disassembled from the module case 110. Accordingly, after the unit battery 120 is assembled into the module case 110, incorrect orientation of the unit battery 120 may be easily verified by pulling out the unit battery 120.

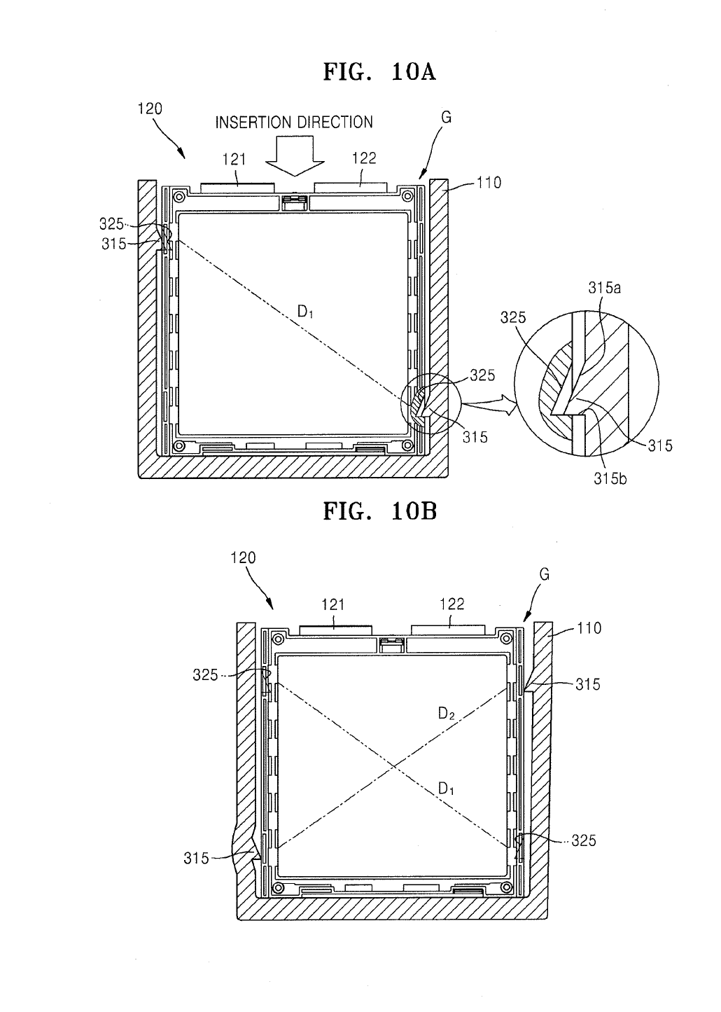

FIGS. 10A and 10B are cross-sectional views for explaining a mis-assembly prevention coupling mechanism applicable to another embodiment. Referring to FIGS. 10A and 10B, the mis-assembly prevention coupling mechanism includes lock portions 325 formed on a unit battery 120 and lock portions 315 formed on the module case 110.

In contrast with the embodiment of FIG. 9A, the lock portions 325 may include notches, and the lock portions 315 may include protrusions received in the lock portions 325.

Each of the lock portions 315 of the module case 110 may protrude in the shape of a wedge having different inclinations. Each of the lock portions 315 may include a first plane 315a inclined in an insertion direction of the unit battery 120, and a second plane 315b that is substantially perpendicular to the insertion direction. The first plane 315a may have an inclined plane shape to reduce resistance to the insertion of the unit battery 120, and the second plane 315b may have an upright or quasi-upright plane shape to form a stopper and block detachment of the unit battery 120 from the module case 110. Each of the lock portions 325 of the unit battery 120 may be shaped to be combined with at least a part of each of the lock portions 315 so as to receive the at least part of each of the lock portions 315. Each of the lock portions 325 of the unit battery 120 may have a convex shape configured to receive at least part of the corresponding lock portion 315. The convex shape may include at least one linearly bent portion as shown in FIG. 10A. The convex shape may also include a non-linearly curved portion (not shown) as long as each of the lock portions 325 can receive at least part of its counterpart 315.

The lock portions 325 of the unit batteries 120 may be two lock portions 325 formed at facing positions on the first diagonal D1, and two lock portions 315 formed on the module case 110 may be arranged on the first diagonal D1 and face the two lock portions 325.

FIG. 10B illustrates a unit battery 120 assembled in an incorrect orientation. Referring to FIG. 10B, for example, when the left and right sides of the unit battery 120 are switched and assembled, the lock portions 325 are arranged on the first diagonal D1 and the lock portions 315 are arranged on the second diagonal D2, so that the lock portions 325 and 315 are not coupled to each other and thus the unit battery 120 is easily disassembled from the module case 110. Accordingly, after the unit battery 120 is assembled into the module case 110, the incorrect orientation of the unit battery 120 may be easily verified by pulling out the unit battery 120.

According to at least one of the above embodiments, left-right orientations of unit batteries may be properly arranged via mis-assembly prevention coupling mechanisms formed between the unit batteries and module case that receive the unit batteries, and thus, proper polarity connections may be secured. In addition, the mis-assembly prevention coupling mechanisms may substantially prevent detachment of the unit batteries from the module case and may properly couple the unit batteries to the module case. Also, the mis-assembly prevention coupling mechanisms may be integrally formed with the unit batteries and the module case, to not use special lock units.

It should be understood that the above embodiments should be considered in a descriptive sense only and not for purposes of limitation. Descriptions of features or aspects within each embodiment should typically be considered as available for other similar features or aspects in other embodiments.

What is claimed is:

1. A battery module comprising:
a module case comprising a plurality of receiving units;
a plurality of unit batteries arranged in the receiving units of the module case, respectively; and
a mis-assembly prevention structure configured to couple the unit batteries to the module case and to substantially align each of the unit batteries with the corresponding receiving unit of the module case,
wherein the mis-assembly prevention structure comprises i) a plurality of first pairs of alignment members formed in the unit batteries, respectively, in substantially diagonal directions with respect to the unit batteries and ii) a plurality of second pairs of alignment members formed in the receiving units of the module case, respectively, in substantially diagonal directions with respect to the receiving units.

2. The battery module of claim 1, wherein adjacent pairs of the first pairs of alignment members are formed in first and second diagonal directions of the unit batteries, respectively, and wherein the first and second diagonal directions intersect each other.

3. The battery module of claim 1, wherein each of the unit batteries comprises i) a first edge via which a first electrode tab and a second electrode tab are drawn out, ii) a second edge opposing the first edge, and iii) a third edge and a fourth edge connected to the first and second edges and are opposite to each other, and wherein the first pairs of alignment members are formed on the third and fourth edges of the unit batteries.

4. The battery module of claim 3, wherein the first and second electrode tabs of one unit battery are disposed adjacent to the second and first electrode tabs of an adjacent unit battery, respectively.

5. The battery module of claim 4, wherein the first and second electrode tabs have opposite polarities, and
wherein the adjacent first and second electrode tabs are serially connected to each other.

6. The battery module of claim 1, wherein adjacent pairs of the second pairs of alignment members are formed in first and second diagonal directions of the receiving units of the module case, respectively, and wherein the first and second diagonal directions intersect each other.

7. The battery module of claim 1, wherein each pair of the first pairs of alignment members comprise two lock portions arranged on a diagonal of the respective unit battery, and
wherein each pair of the second pairs of alignment members comprise two lock portions arranged on a diagonal of the respective receiving unit of the module case so as to engage with the lock portions of the unit battery.

8. The battery module of claim 7, wherein the lock portions of one unit battery are formed on a first diagonal, and wherein the lock portions of an adjacent unit battery are formed on a second diagonal intersecting the first diagonal.

9. The battery module of claim 7, wherein the receiving units comprise grooves configured to at least partially receive first alignment members of the first pairs of alignment members of the unit batteries, respectively.

10. The battery module of claim 7, wherein the lock portions of the unit battery are formed on a first diagonal of the corresponding unit battery, wherein the lock portions of the module case are formed on the first diagonal of the corresponding receiving unit of the module case, and wherein no lock portions of the corresponding unit battery and no lock portions of the corresponding receiving unit of the module case are formed on a second diagonal intersecting the first diagonal.

11. The battery module of claim 7, wherein the lock portions of the unit battery and the lock portions of the module case comprise protrusions having a wedge shape.

12. The battery module of claim 11, wherein each of the lock portions of the unit battery and the module case comprises:
a first surface inclined in a direction where the unit batteries are inserted into the receiving units of the module case; and
a second surface that is substantially perpendicular to the insertion direction to substantially block deviation of the unit battery from the module case.

13. The battery module of claim 12, wherein the second surfaces of the lock portions of the unit battery and the second surfaces of the lock portions of the module case contact each other and form a stopper to substantially block deviations from each other.

14. The battery module of claim 7, wherein one of i) the lock portions of the unit battery and ii) the lock portions of the module case comprise a protrusion, and wherein the other comprises a notch configured to receive the protrusion.

15. The battery module of claim 14, wherein the protrusion and the notch have substantially similar shapes.

16. The battery module of claim 1, further comprising an insulation plate, which covers an upper surface of an array of the unit batteries, disposed on the module case.

17. The battery module of claim 16, wherein a plurality of slit-type openings through which electrode tabs of the unit batteries are drawn out are formed substantially parallel with each other in the insulation plate.

18. The battery module of claim 17, wherein a first electrode tab of one unit battery at least partially overlaps with a second electrode tab of an adjacent unit battery on the insulation plate, and
wherein the first and second electrode tabs are electrically connected to each other via a bus bar seated on the insulation plate.

19. A battery module comprising:
a module case comprising a plurality of receiving units; and
a plurality of unit batteries arranged in the receiving units of the module case, respectively,
wherein a plurality of first pairs of alignment members are formed in the unit batteries, respectively, in substantially diagonal directions with respect to the unit batteries,
wherein a plurality of second pairs of alignment members are formed in the receiving units of the module case, respectively, in substantially diagonal directions with respect to the receiving units,
and wherein each pair of the first pairs of alignment members is configured to at least partially engage with the corresponding second pair of alignment members.

20. The battery module of claim 19, wherein adjacent pairs of the first pairs of alignment members are formed in first and second diagonal directions of the unit batteries, respectively, wherein the first and second diagonal directions cross each other,
wherein adjacent pairs of the second pairs of alignment members are formed in third and fourth diagonal directions of the receiving units, respectively, and wherein the third and fourth diagonal directions cross each other.
